(19) United States
(12) Patent Application Publication
(10) Pub. No.: US 2012/0127310 A1
(43) Pub. Date: May 24, 2012

(54) APPARATUS AND METHOD FOR CONTROLLING A VEHICLE CAMERA

(75) Inventor: Dae Hyun Kim, Gyeongsan (KR)

(73) Assignee: SL CORPORATION, Daegu (KR)

(21) Appl. No.: 13/277,745

(22) Filed: Oct. 20, 2011

(30) Foreign Application Priority Data
Nov. 18, 2010 (KR) 10-2010-0114974

(51) Int. Cl. H04N 7/18

(52) U.S. Cl. 348/148; 348/E07.085

(57) ABSTRACT

An apparatus and method for adaptively controlling an angle of a camera when the height of a vehicle is changed are provided. The apparatus for controlling a vehicle camera includes at least one sensor which detects variation in height of the vehicle, a rotational angle calculation unit which calculates a rotational angle of the vehicle to compensate the detected variation in height of the vehicle, and a camera control unit which controls the image pickup angle of the vehicle camera based on the calculated rotational angle.

### CROSS-REFERENCE TO RELATED APPLICATION

This application claims priority from Korean Patent Application No. 10-2010-0114974 filed on Nov. 18, 2010, and all the benefits accruing therefrom under 35 U.S.C. 119, the contents of which in its entirety are herein incorporated by reference.

### BACKGROUND

1. Field of the Invention

The present invention relates to a technology for controlling an angle of a vehicle camera, and more particularly to an apparatus and method for adaptively controlling the angle of the camera when the height of the vehicle is changed.

2. Description of the Related Art

During operation of a vehicle, it is important to perceive information including the number and position(s) of preceding vehicles. In particular, recently, it becomes more important with development of a dynamic control technology of headlights. The dynamic control technology of headlights means a technology for dynamically controlling and illuminating the headlights appropriately based on the environment surrounding a moving vehicle. That is, beam patterns of the headlights are optimally controlled to meet various conditions such as the number, distance(s) and direction(s) of vehicles, and curvature of the road in the surrounding environment. This technological development is being made in response to the demand for increases convenience and safety of drivers in addition to improvement of vehicle performance.

There are various methods for acquiring information about preceding vehicles. A method of irradiating radar beams, receiving reflected waves, and determining the distance and speed (and direction) using a Doppler effect is a relatively accurate conventional technique, but has an economic disadvantage. Accordingly, many studies have been conducted on a method of processing an image of a preceding vehicle using a relatively inexpensive vehicle camera to acquire various types of information, and controlling a currently moving vehicle using the acquired information.

However, one associated problem is the height of the vehicle often chances frequently due to various factors. As a first example, the vehicle height of the front wheels or the vehicle height of the rear wheels may be changed by an operation of the driver as one of options of certain vehicles. In this case, the driver may actively change the height of the vehicle according to the moving mode of the vehicle or the surrounding environment. For example, the driver may decrease the height of the vehicle in a sports mode, or increase the height of the vehicle in a region in which there are speed bumps.

As a second example, the height of the vehicle may be changed according to the current state of the vehicle regardless of the driver's intention. For example, the vehicle height of rear wheels may be reduced if a heavy object is loaded in a trunk of the vehicle or if several people are seated on the back seats of the vehicle. Furthermore, the vehicle height of the front wheels may be reduced if the tire pressure of the front wheels is insufficient.

As described above, in order to accurately perceive the information of the preceding vehicle, particularly, in order to calculate a distance to the preceding vehicle, it is required to constantly maintain an image pickup angle of the camera regardless of changes in the environment. However, if the height of the vehicle is changed as described above, the image pickup angle of the camera is also changed. Accordingly, it is difficult to accurately perceive the information of the preceding vehicle.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides an apparatus and method capable of constantly maintaining an image pickup angle of a vehicle camera even if a height of a vehicle is changed due to various factors.

The objects of the present invention are not limited thereto, and the other objects of the present invention will be described in or be apparent from the following description of the embodiments.

According to an aspect of the present invention, there is provided an apparatus for controlling a vehicle camera to constantly maintain an image pickup angle of the vehicle camera regardless of variation in height of a vehicle. More specifically, the apparatus includes at least one sensor which detects variation in height of the vehicle, a rotational angle calculation unit which calculates a rotational angle of the vehicle to compensate the detected variation in height of the vehicle, and a camera control unit which controls the image pickup angle of the vehicle camera based on the calculated rotational angle.

According to another aspect of the present invention, there is provided an apparatus for controlling a vehicle camera to maintain an image displayed in a vehicle to have a fixed view regardless of variation in height of the vehicle. More specifically, the apparatus includes at least one sensor which detects variation in height of the vehicle, a rotational angle calculation unit which calculates a rotational angle of the vehicle to compensate the detected variation in height of the vehicle, a camera which is fixed relatively to the vehicle to capture an image, and an image processing unit which extracts a sample image from the captured image based on the calculated rotational angle.

Advantageously, the present invention improves accuracy of an imaging technology for processing an image of a preceding vehicle for dynamic control of headlights by actively and constantly controlling an image pickup angle of a vehicle camera. In addition, there is an effect of promoting convenience and safety of drivers by quickly responding to changes in the surrounding environment of a moving vehicle without incurring high costs.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram showing a configuration of an apparatus for controlling a vehicle camera in accordance with an exemplary embodiment of the present invention;

FIG. 2 exemplarily illustrates a vehicle, a first vehicle height and a second vehicle height;

FIG. 3 illustrates heights of the vehicle and an image pickup angle of the camera;

FIG. 4 illustrates a case where the height of rear wheels is increased in accordance with a first exemplary embodiment of the present invention;

FIG. 5 illustrates a relationship between an offset and a rotational angle of the vehicle in the case of FIG. 4;

FIG. 6 shows the results of correcting the direction of the camera based on the rotational angle of FIG. 5;

FIG. 7 illustrates a case where the height of front wheels is increased in accordance with the first exemplary embodiment of the present invention;

FIG. 8 illustrates a relationship between an offset and a rotational angle of the vehicle in the case of FIG. 7;

FIG. 9 shows the results of correcting the direction of the camera based on the rotational angle of FIG. 8;

FIG. 10 shows an image captured in accordance with a second exemplary embodiment of the present invention;

FIG. 11 shows an image captured when the height of front wheels is increased in a state of FIG. 10;

FIG. 12 shows the results of restoring the captured image to its original state by controlling the camera downward;

FIG. 13 shows an image captured by a camera and a sample image when there is no change in height of the vehicle;

FIG. 14 shows an image captured by a camera and a sample image when the vehicle is rotated slightly upward due to variation in height of the vehicle;

FIG. 15 shows an image captured by a camera and a sample image when the vehicle is rotated slightly downward due to variation in height of the vehicle;

FIG. 16 shows a sample image obtained in a fixed direction despite variation in height of the vehicle; and

FIG. 17 is a block diagram showing a configuration of an apparatus for controlling a vehicle camera in accordance with a third exemplary embodiment of the present invention.

### DETAILED DESCRIPTION OF THE DISCLOSURE

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. The same reference numbers indicate the same components throughout the specification. In the attached figures, the thickness of layers and regions is exaggerated for clarity.

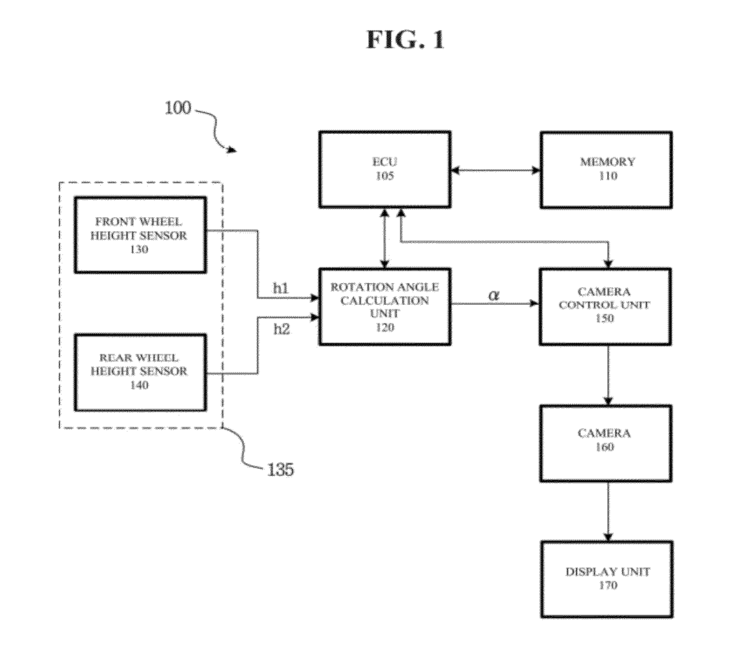

FIG. 1 is a block diagram showing a configuration of an apparatus 100 for controlling a vehicle camera in accordance with an exemplary embodiment of the present invention. The apparatus 100 for controlling a vehicle camera is an apparatus for constantly maintaining an image pickup angle of a vehicle camera regardless of variation in height of a vehicle. The apparatus 100 for controlling a vehicle camera may include an electronic control unit (ECU) 105, a memory 110, a rotational angle calculation unit 120, a sensor unit 135, a camera control unit 150, a camera 160, and a display unit 170. Those skilled in the art will understand that the apparatus 100 for controlling a vehicle camera may also include the respective units mounted on a printed circuit board with the ECU in the vehicle or the units (e.g., the camera control unit 150, the camera 160 and the display unit 170) provided separately from the printed circuit board.

A front image of the vehicle is captured by the camera 160. For example, the camera 160 may include an image sensor and an analog-to-digital converter (ADC). The image sensor may include a charge coupled device (CCD), complementary metal oxide semiconductor (CMOS), or other optical imaging device. The ADC converts the image captured by the image sensor into a digital signal. The digital signal is provided to the ECU 105 such that an image processing operation is performed.

The ECU 105 processes the image obtained by the camera, analyzes information of a preceding vehicle, and controls the operation of the vehicle based on the analyzed information. The controls of the operation of the vehicle include an engine control, a brake control, a steering control, a headlight control and the like. The results of controlling the operation of the vehicle or the image captured by the camera 160 may be provided to a driver through the display unit 170 embodied as a liquid crystal display (LCD), light emitting diode (LED), head-up display (HUD) or various types of displays.

The sensor unit 135 includes at least one height detection sensor to detect variation in height of the vehicle. Preferably, the sensor unit 135 includes a front wheel height sensor 130 which detects a first vehicle height at the front wheels of the vehicle, and a rear wheel height sensor 140 which detects a second vehicle height at the rear wheels of the vehicle. The sensor unit 135 may be configured as a Hall IC or other well-known unit.

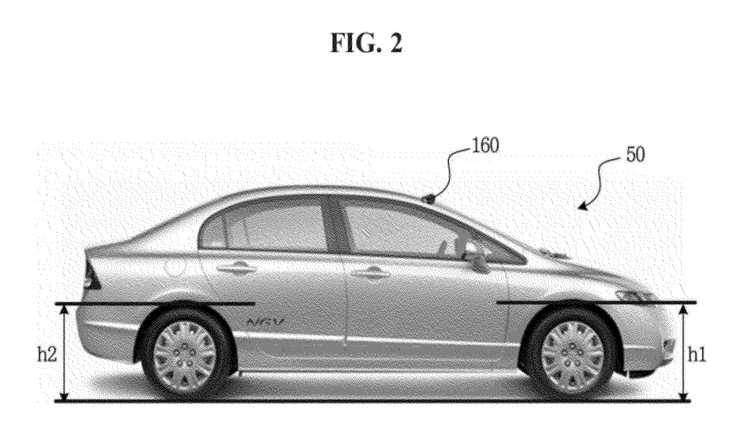

FIG. 2 exemplarily illustrates a vehicle 50, a first vehicle height h1, and a second vehicle height h2. As shown in FIG. 2, the first vehicle height h1 represents a height of the vehicle at a position of front wheels, and the second vehicle height h2 represents a height of the vehicle at a position located at rear wheels. Generally, the camera 160 is provided at an upper portion of the vehicle 50 to facilitate image capture. The rotational angle calculation unit 120 calculates a rotational angle of the vehicle to compensate the detected variation in the height of the vehicle.

In a first embodiment, in case of detecting variation in at least one of the first vehicle height and the second vehicle height, the rotational angle calculation unit 120 computes a rotational angle of the vehicle from a distance between the position of front wheels and the position of rear wheels and an offset determined by combination of the first vehicle height and the second vehicle height, and then calculates a rotational angle compensating the computed rotational angle.

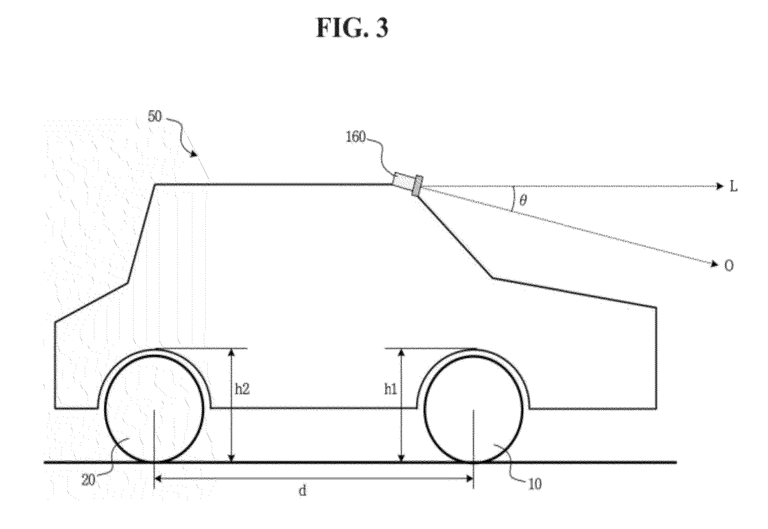

In a second embodiment, the rotational angle calculation unit 120 calculates the rotational angle based on a mapping table defining a relationship between the first vehicle height, the second vehicle height and the rotational angle. The mapping table may be stored in the memory 110. The operation of calculating the rotational angle according to the first and second embodiments will be described in detail with reference to FIGS. 3 to 12.

The camera control unit 150 controls the image pickup angle of the vehicle camera based on the rotational angle provided from the rotational angle calculation unit 120. To control the image pickup angle, the camera control unit 150 includes a mechanical driving mechanism having a step motor, a servo motor and the like. Since a technology for controlling an angle of an object according to a given angle is a well-known technology which is widely used in various fields of electronic/mechanical industries (e.g., closed circuit cameras and cars), a detailed description thereof will be omitted.

The vehicle heights h1 and h2 detected by the sensors 130 and 140 may be changed slightly due to unevenness of the road or vibration of the vehicle. If the camera 160 is controlled adaptively even in this case, it may cause a waste of resources. Accordingly, the camera control unit 150 controls the image pickup angle, preferably, only when the rotational angle is equal to or greater than a predetermined threshold value.

FIG. 3 illustrates the heights of the vehicle and the image pickup angle of the camera. The heights of the vehicle at positions at the front wheels 10 and rear wheels 20 of the vehicle 50 are represented by h1 and h2, respectively. The distance between the rotational axis of the front wheels 10 and a rotational axis of the rear wheels 20, i.e., a wheelbase, is represented by d. The camera 160 is generally installed on the upper portion of the vehicle 50, and has a factory default setting such that it is oriented in a downward direction O inclined by a predetermined angle θ from a horizontal direction L.

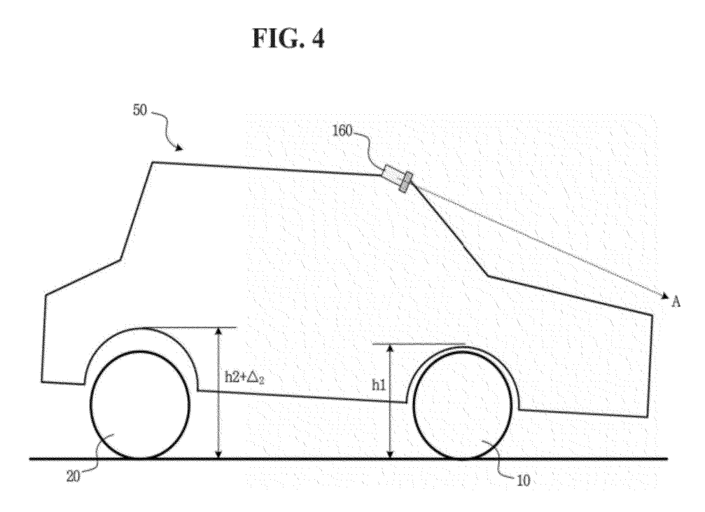

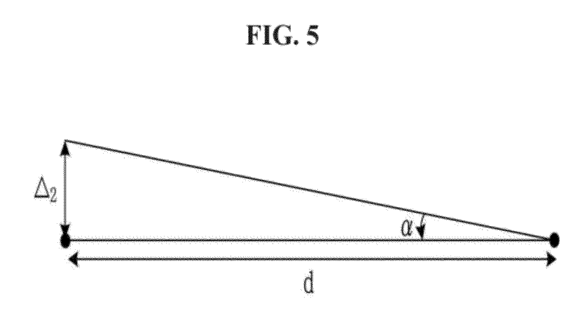

FIGS. 4 to 6 illustrate a case where the vehicle height h2 of the rear wheels 20 is increased from an original value. Referring to FIG. 4, the vehicle height h2 of the rear wheels 20 is increased by Δ₂. Accordingly, the camera 160 installed on the vehicle 50 is oriented in a downward direction A lower than the original direction O of FIG. 3 unless additional controls are applied. An angle α between the original direction O and the downward direction A, i.e., the rotational angle of the vehicle, may be calculated by the following Eq. 1 with reference to FIG. 5.

α=tan⁻¹(Δ₂/d) Eq. 1

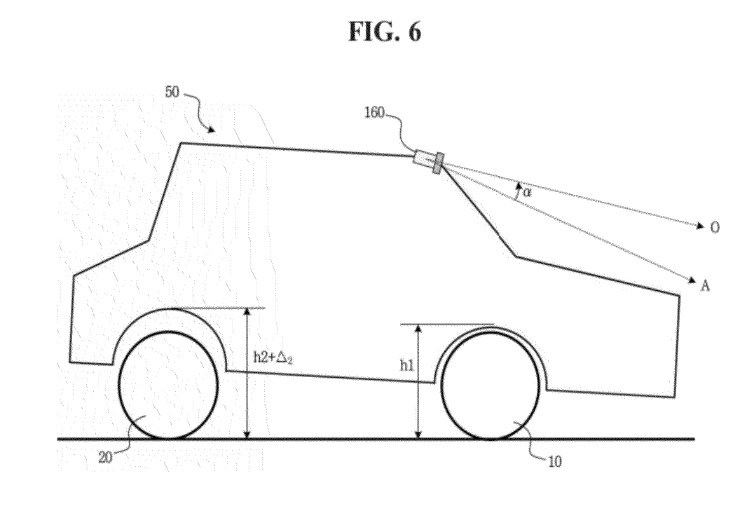

Referring to FIG. 6, the camera control unit 150 rotates the camera 160 in an upward direction by the calculated angle α. That is, the rotational angle of the vehicle and the angle compensating the rotational angle have the same magnitude but opposite directions. Accordingly, the distorted direction A of the camera as shown in FIG. 4 is corrected to the original direction O.

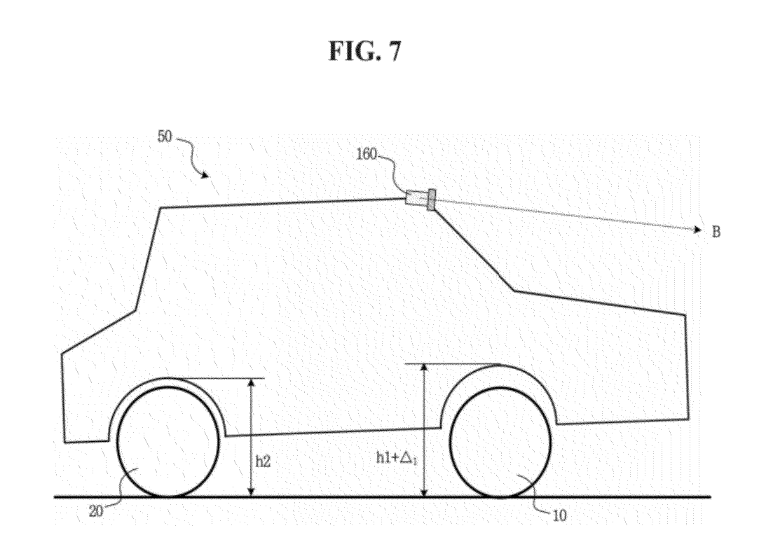

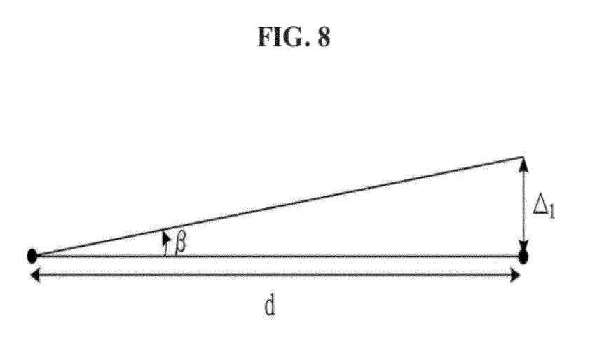

Meanwhile, FIGS. 7 to 9 illustrate a case where the vehicle height h1 of the front wheels 10 is increased from an original value. Referring to FIG. 7, the vehicle height h1 of the front wheels 10 is increased by Δ₁. Accordingly, the camera 160 installed on the vehicle 50 is oriented in an upward direction B higher than the original direction O of FIG. 3 unless additional controls are applied. An angle β between the original direction O and the upward direction B, i.e., the rotational angle of the vehicle, may be calculated by the following Eq. 2 with reference to FIG. 8.

β=tan⁻¹(Δ₁/d) Eq. 2

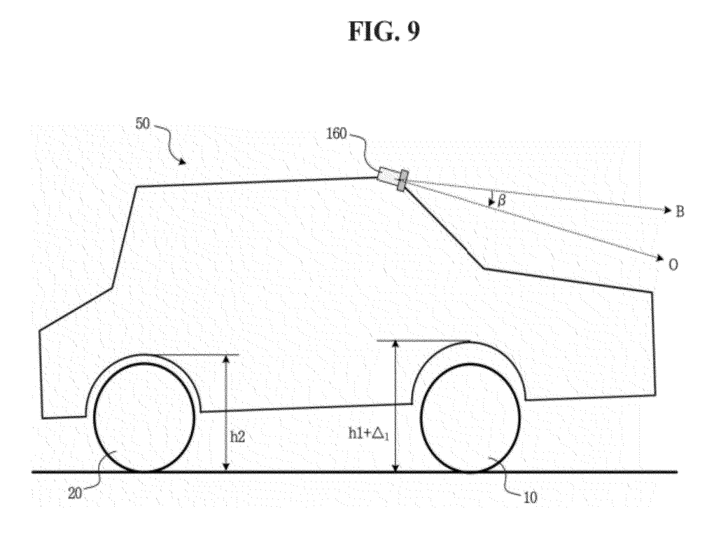

Referring to FIG. 9, the camera control unit 150 rotates the camera 160 in a downward direction by the calculated angle β. In the same way, the rotational angle of the vehicle and the angle compensating the rotational angle have the same magnitude and opposite directions. Accordingly, the distorted direction B of the camera as shown in FIG. 7 is corrected to the original direction O.

The method of controlling the direction of the camera in accordance with the first embodiment has been described with reference to FIGS. 4 to 9. In this case, although an example in which any one of the vehicle height h1 of the front wheels and the vehicle height h2 of the rear wheels is changed has been described, this method may be applied to a case where the vehicle height h1 of the front wheels and the vehicle height h2 of the rear wheels are changed at the same time. This is because geometric relationships of FIGS. 5 and 8 can be also obtained by a relative difference value between the vehicle height h1 of the front wheels and the vehicle height h2 of the rear wheels (hereinafter, defined as an offset in the present invention).

Although the direction of the camera can be simply controlled by the calculation of equations in the first embodiment, additional consideration is needed to more precisely control the direction of the camera. For example, in a case where the vehicle height h1 of the front wheels and the vehicle height h2 of the rear wheels increase or decrease by the same amount, since the rotational angle of the vehicle is zero, the camera control unit 150 does not control the direction of the camera 160. However, in actually, since the height of the vehicle increases in parallel to the ground even though there is no rotation of the vehicle, an image inputted to the camera can be changed.

Accordingly, it is necessary to take into consideration absolute values of the vehicle height h1 of the front wheels and the vehicle height h2 of the rear wheels in addition to the rotational angle of the vehicle in order to precisely control the direction of the camera 160. However, in this case, it is not easy to represent it as one geometric expression because it is affected by various factors such as an initial direction and installation position of the camera 160. Accordingly, if calibration is performed in advance in a factory and the results thereof are stored as a mapping table, a necessary angle for compensation may be determined by referring to the mapping table during an actual operation.

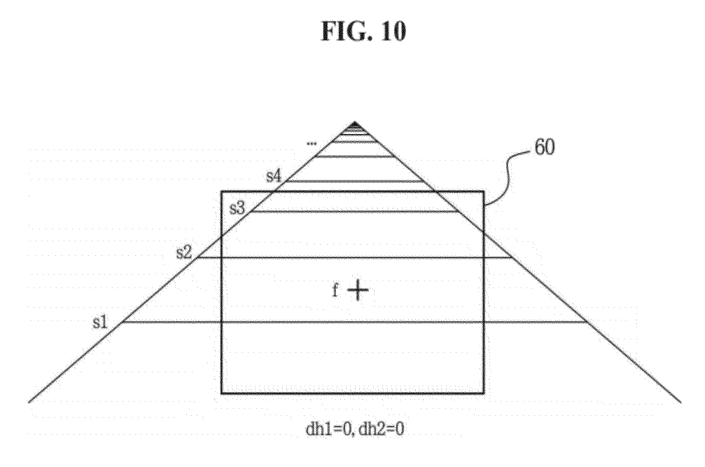

FIGS. 10 to 12 illustrate a method for creating the mapping table in accordance with the second embodiment of the present invention.

Referring to FIG. 10, a plurality of horizontal lines s1, s2, s3, s4, etc., are arranged at equal intervals indicated on a virtual road surface. The center of an image 60 captured by the camera 160 of the vehicle is indicated by fin a state where both variations dh1 and dh2 of the initial vehicle heights h1 and h2 are zero. The position of the center f of the image 60 may be simply measured by identifying the plurality of horizontal lines.

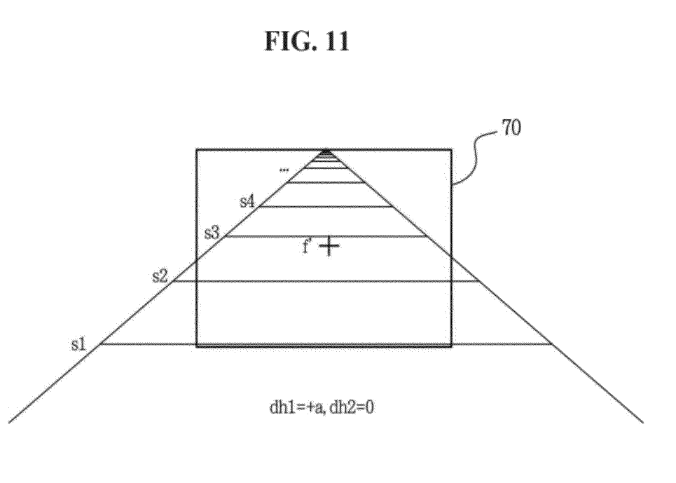

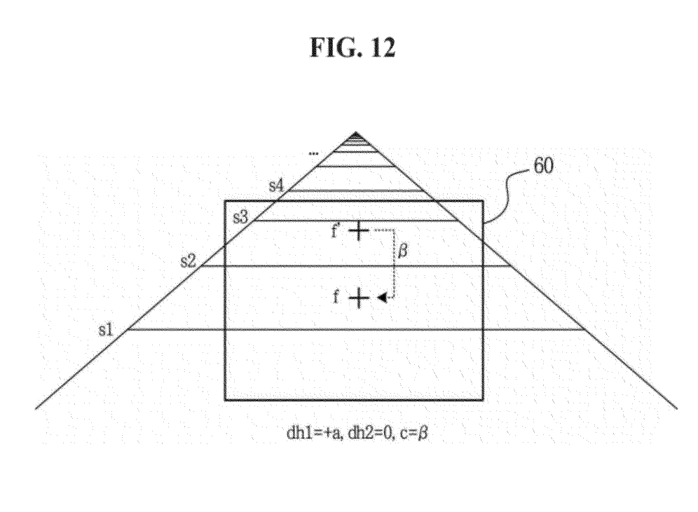

Then, as shown in FIG. 11, if the variation dh1 of the vehicle height h1 is +a and the vehicle height h2 is fixed, a newly captured image 70 has a changed center f′. Finally, as shown in FIG. 12, in the state where the variation dh1 of the vehicle height h1 is +a, the direction of the camera 160 is controlled downward so that the captured image 60 has the original center f. In this case, if a rotational angle c of the camera 160 is β, a data set of (+a, 0, β) is created for the variation dh1 of the vehicle height h1, the variation dh2 of the vehicle height h2 and the rotational angle c of the camera. All rotational angles c of the camera for compensation are calculated by repeating this method while varying the vehicle heights h1 and h2, thereby completing the mapping table. For example, when twenty values of the vehicle height h1 and twenty values of the vehicle height h2 are sampled, data sets need to be created by repeating this method at least 400 times. As described above, when the mapping table which includes a plurality of data sets is created, the actual rotational angle c of the vehicle can be calculated by performing interpolation on the representative values of the data sets.

In the above-described embodiments, when an area captured by the camera is changed due to variation in height of the vehicle, it is possible to capture a fixed area in the camera by controlling the direction of the camera. However, in another embodiment (third embodiment), although a variation in height of the vehicle occurs, the same effect may be provided to a driver (i.e., the driver often does not notice the variation in height of the vehicle) by appropriately processing and displaying the captured image while the camera is in a fixed state.

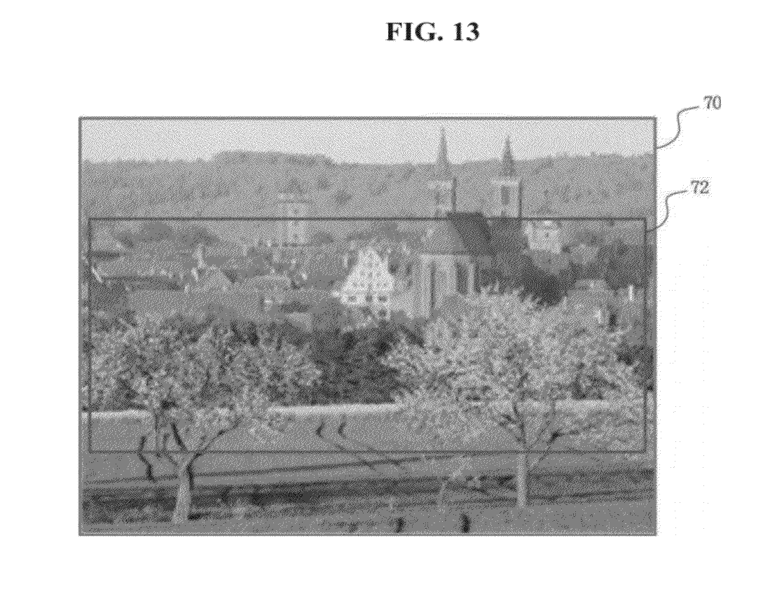

FIGS. 13 to 16 illustrate operational principles in accordance with the third embodiment of the present invention. Among these, FIG. 13 shows a case where there is no change in height of the vehicle.

First, in a state where there is no change in height of the vehicle, the image 70 captured by the camera may be different from a sample image 72 actually displayed in the display unit of the vehicle. That is, only the sample image 72 located at a predetermined position may be extracted from the entire image 70 captured according to the size of an image pickup device array of the camera and displayed in the display unit of the vehicle. Accordingly, the sample image 72 has a fixed size which is relatively smaller than that of the captured image 70, and is located at a fixed position (e.g., center) of the captured image 70.

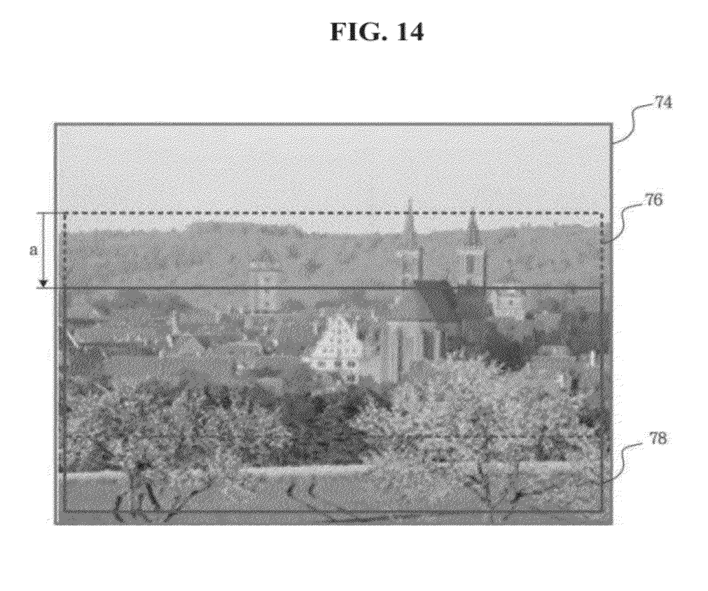

FIG. 14 illustrates a case where the vehicle is rotated slightly upward due to variation in height of the vehicle. In this case, an image 74 captured by the camera has a higher field of view than the image 70 captured when there is no change in height of the vehicle. In this situation, a sample image 76 also has a higher view than the sample image 72. However, if only a shifted sample image 78 obtained by moving a position of the sample image 76 downward by a vertical shift value (represented by a in FIG. 14) is extracted and displayed in the display unit, the driver cannot perceive a change in camera angle due to a variation in height of the vehicle.

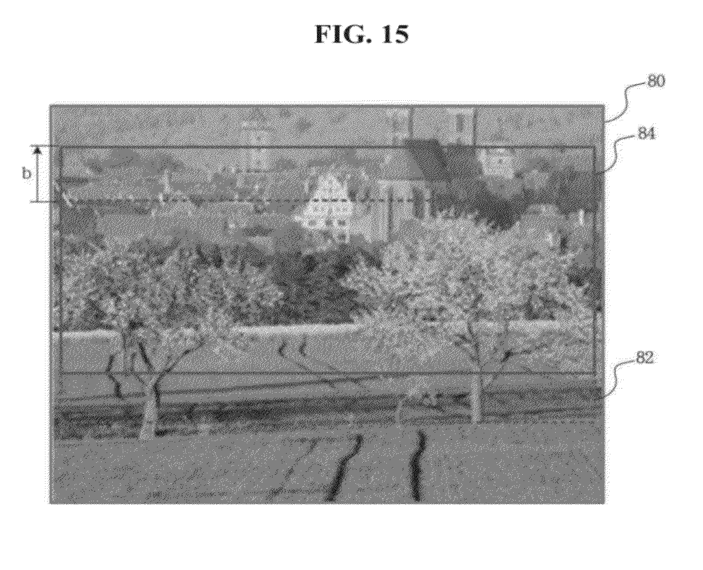

On the other hand, FIG. 15 illustrates a case where the vehicle is rotated slightly downward due to create a variation in height of the vehicle. In this case, an image 80 captured by the camera has a lower field of view than the image 70 captured when there is no change in height of the vehicle. In this situation, a sample image 82 also has a lower field of view than the sample image 72. However, if only a shifted sample image 84 obtained by moving a position of the sample image 82 upward by a vertical shift value (represented by b in FIG. 15) is extracted and displayed in the display unit, the driver cannot perceive a change in camera angle.

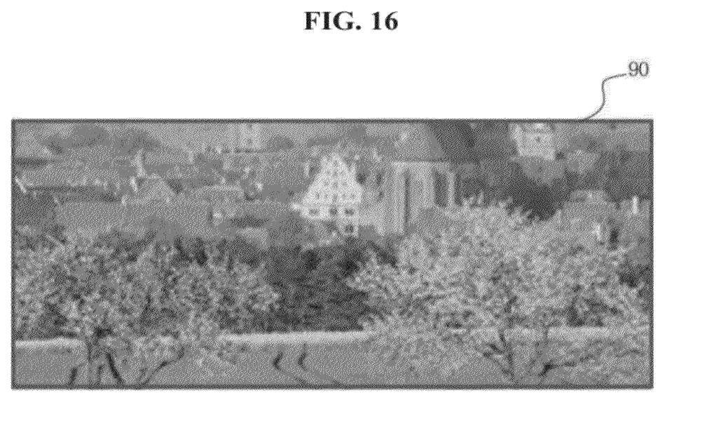

Consequently, in all cases of FIGS. 13 to 15, the image displayed in the display unit and provided to the driver is an image extracted in a predetermined direction to have a fixed position as illustrated in FIG. 16. As described above, in the third embodiment of the present invention, since an area provided by the image pickup device array of the camera is vertically larger than an actually displayed area, it may require an image pickup device having a relatively high resolution, or it may be impossible to completely extract an image at the same position due to the large variation in height of the vehicle. However, in the third embodiment, it is advantageous in that it is possible to provide an image captured in a fixed direction to the driver simply by processing an image without requiring a driving unit for controlling the movement of the camera. Accordingly, among the three embodiments, an appropriate embodiment may be selected as needed.

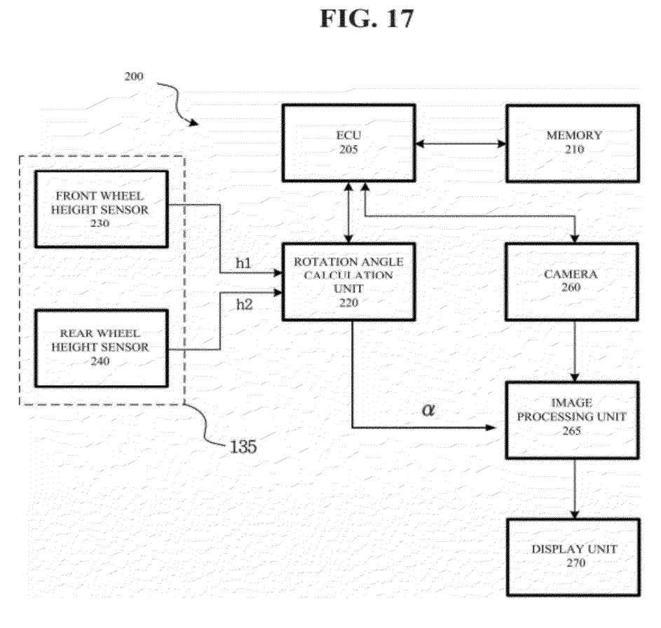

FIG. 17 is a block diagram showing a configuration of an apparatus 200 for controlling a vehicle camera in accordance with the third embodiment of the present invention. The apparatus 200 for controlling a vehicle camera is different from the apparatus 100 for controlling a vehicle camera shown in FIG. 1 in that the camera control unit 150 is removed and an image processing unit 265 is added. An electronic control unit (ECU) 205, a memory 210, a rotational angle calculation unit 220, a sensor unit 235, a camera 260, and a display unit 270 have the same functions as the ECU 105, the memory 110, the rotational angle calculation unit 120, the sensor unit 135, the camera 160, and the display unit 170, respectively.

However, a rotational angle α provided from the rotational angle calculation unit 220 is provided to the image processing unit 265, and the image processing unit 265 extracts a sample image by upward or downward movement based on the rotational angle α to compensate an influence of the rotational angle α. In this case, the image extracted by the image processing unit 265 is provided to the driver through the display unit 270.

Although there are various methods for obtaining a relationship between the rotational angle α and the vertical shift values (a of FIG. 14 and b of FIG. 15) of the sample images, a method may be used in which a mapping table representing a relationship between the rotational angle α and the vertical shift values is obtained by pre-calibration before the vehicle's leaves the factory and stored in the memory 210. In this case, the image processing unit 265 may always determine the vertical shift value in the current situation through the stored mapping table.

However, as mentioned in the description of FIGS. 10 to 12, it may be difficult to accurately represent the state of the vehicle only using the rotational angle. Accordingly, it is necessary to take into consideration absolute values of the vehicle height h1 of the front wheels and the vehicle height h2 of the rear wheels in addition to the rotational angle of the vehicle in order to obtain more accurate results. Accordingly, and more preferably, a mapping table representing a relationship among the vehicle height h1 of the front wheels, the vehicle height h2 of the rear wheels (or variation in vehicle height of the front wheels, variation in vehicle height of the rear wheels) and the vertical shift values of the sample image may be created through the pre-calibration before the vehicle's release and stored in the memory 210. Then, the image processing unit 265 may determine the vertical shift value in the current situation through the stored mapping table.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

It should be further noted that logic and control of the present invention may be embodied as computer readable media on a computer readable medium containing executable program instructions executed by a processor or ECU to control the apparatus of the illustrative embodiment of the present invention. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, for example, a CAN network.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling a vehicle camera to constantly maintain an image pickup angle of the vehicle camera regardless of variation in height of a vehicle, the apparatus comprising:
at least one sensor configured to detect variation in height of the vehicle;
a rotational angle calculation unit configured to calculate a rotational angle of the vehicle to compensate the detected variation in height of the vehicle; and
a camera control unit configured to control the image pickup angle of the vehicle camera based on the calculated rotation angle.

2. The apparatus of claim 1, wherein the at least one sensor comprises a front wheel height sensor which detects a first vehicle height at a position of front wheels of the vehicle, and a rear wheel height sensor which detects a second vehicle height at a position of rear wheels of vehicle.

3. The apparatus of claim 2, wherein when a variation in at least one of the first vehicle height and the second vehicle height is detected, the rotational angle calculation unit computes a rotational angle of the vehicle from a distance between the position of front wheels and the position of rear wheels and an offset determined by combination of the first vehicle height and the second vehicle height, and calculates the rotational angle compensating the computed rotational angle.

4. The apparatus of claim 2, wherein the rotational angle calculation unit is configured to calculate the rotational angle based on a mapping table which is stored in a specific memory and defines a relationship between the first vehicle height, the second vehicle height and the rotational angle.

5. The apparatus of claim 1, further comprising a display unit configured to display an image captured by the vehicle camera.

6. The apparatus of claim 1, wherein the camera control unit controls the image pickup angle only when the rotational angle is equal to or greater than a predetermined threshold value.

7. The apparatus of claim 1, further comprising an electronic control unit (ECU) that is configured to process an image obtained by the camera, analyzes information of a preceding vehicle, and controls an operation of the vehicle based on the analyzed information.

8. An apparatus for controlling a vehicle camera to maintain an image displayed in a vehicle to have a fixed view regardless of variation in height of the vehicle, the apparatus comprising:
at least one sensor configured to detect variation in height of the vehicle;
a rotational angle calculation unit configured to calculate a rotational angle of the vehicle to compensate the detected variation in height of the vehicle;
a camera fixed relatively to the vehicle to capture an image; and
an image processing unit configured to extract a sample image from the captured image based on the calculated rotational angle.

9. The apparatus of claim 8, wherein the image processing unit acquires a vertical shift value to compensate the variation in height of the vehicle based on the calculated rotational angle, and extracts the sample image shifted by the acquired vertical shift value.

10. The apparatus of claim 9, further comprising a memory configured to store a mapping table representing a relationship between the calculated rotational angle and the vertical shift value.

11. The apparatus of claim 9, further comprising a memory configured to store a mapping table representing a relationship between the variation in height of the vehicle and the vertical shift value.

12. A method for controlling a vehicle camera to constantly maintain an image pickup angle of the vehicle camera regardless of variation in height of a vehicle, the method comprising:
detecting by at least one sensor variation in height of the vehicle;
calculating, by a first unit, a rotational angle of the vehicle to compensate the detected variation in height of the vehicle; and
controlling, by a second unit, the image pickup angle of the vehicle camera based on the calculated rotation angle.

13. A computer readable medium containing executable program instructions executed by a processor, comprising:
program instructions that control at least one sensor to calculate variation in height of the vehicle;
program instructions that control a first unit to calculate a rotational angle of the vehicle to compensate the detected variation in height of the vehicle; and
program instructions that control the image pickup angle of the vehicle camera based on the calculated rotation angle.
